(19) United States
(12) Patent Application Publication
(10) Pub. No.: US 2013/0054293 A1
(43) Pub. Date: Feb. 28, 2013

(54) SYSTEM AND DATABASE FOR MATCHING EVENT VENDORS WITH EVENT PLANNERS IN REAL-TIME.

(71) Applicants: Nayana Sen, Saint Augustine, FL (US); Ranjan Kumar Sen, Orange Park, FL (US)

(72) Inventors: Nayana Sen, Saint Augustine, FL (US); Ranjan Kumar Sen, Orange Park, FL (US)

(21) Appl. No.: 13/590,580

(22) Filed: Aug. 21, 2012

Related U.S. Application Data
(60) Provisional application No. 61/525,989, filed on Aug. 22, 2011.

(51) Int. Cl. G06Q 10/10

(52) U.S. Cl. 705/7.18

(57) ABSTRACT

A process for matching event planners with vendors using real-time information. with the steps of: a server having a memory configured to store data and instructions, a database stored in the memory and accessed by vendors and event planners through a website and, a processor associated with the server and configured to execute instructions to: receive and store in the database profiles of a plurality of vendors, receive and store in the database criteria of planner, Method, in response to the profile of the planner, access the database and match the planner with at least one vendor having a profile that meets at least one criteria of the planner, receive an input from the planner indicating one or more vendors the event planner would like to obtain more information from, and in response to the planner accepting contact by the selected vendors, transmit an e-mail notification to the selected vendors.

### CROSS REFERENCE TO RELATED APPLICATIONS

This application is based on provisional application Ser. No. 61/525,989, filed on Aug. 22, 2011.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of internet marketing and more specifically to A System and Database for matching event vendors with event planners in real-time.

Event planning for major events such as weddings or even milestone birthdays require a significant amount of planning and coordination by an event planner with vendors that meet their needs. Details may require multiple phone calls or emails to check availability of vendors, followed by questions related to cost. Weddings are often planned by professional planners who charge to conduct these errands on behalf of the bride or bride's may plan the wedding themselves with the aid of online tools.

These methods are time consuming for the event planner and frustrating for the wedding vendor that is trying to sell a service. Event vendors must be able to earn money by booking brides; however a good portion of their time is dedicated to simply answering basic questions for event planners that may or may not result in a sale.

There are several websites that provide event vendor information and a search on any major search engine under the term “online wedding planning” will show such results. These websites essentially function as an online magazine, showing static or non-changing information to all parties. Other wedding planning websites offer some form of interactive tools such as budget tracker, guest list, or even personalized webpages.

These other inventions are only similar to the current invention in that these websites offer brides with wedding related information and offer the bride a method to expedite the wedding planning process.

Prior technology requires the bride or the planner to contact the vendor individually to find out if they are available on a specific date or check calendars individually.

Information presented is the same for all potential consumers, i.e. all brides will see the same information at the onset such as price. The current methodology does not take into account that vendors may be negotiable on price or a discount may be available on certain days or that they may charge different amounts for less experienced staff. There is no significant reduction of time for the bride or event planner using these other systems in terms of searching for vendors and identifying which vendors can best serve their needs.

### BRIEF SUMMARY OF THE INVENTION

The primary object of the invention is to provide a method, apparatus, and program for event vendors to create customized data that would allow a business to target event planners based on date of event, as well as budget and location.

Another object of the invention is to provide a system for advantageously enabling event planners to significantly reduce the amount of time needed to interact with multiple vendors across multiple categories for events that require that level of participation, such as weddings.

Another object of the invention is to provide a system enabling event vendors to update their information as often as needed, so the event planner will see information in real-time.

A further object of the invention is to provide a system enabling event vendors to provide information without being online or by the phone.

Yet another object of the invention is to provide a system that gives the event vendor a way to create an automated referral system.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed A System and Database for matching event vendors with event planners in real-time comprising the steps of: a server having a memory configured to store data and instructions , a database stored in the memory and accessed by vendors and event planners through an internet website and, a processor associated with the server and configured to execute instructions to: receive and store in the database profiles of a plurality of vendors, including a location of each vendor, one or more categories of services offered by each vendor, and charges for the services of each vendor, receive and store in the database criteria of a planner of an event, including a date, time and place of the event, a budget for the event, a number of guests, and categories, Method, in response to the profile of the planner, access the database and match the planner with at least one vendor having a profile that meets at least one criteria of the planner, output to the planner a list of the at least one matching vendor, including vendors that are available at the time of the event, receive an input from the planner indicating one or more vendors the event planner would like to obtain more information from, receive an input from the planner indicating whether the planner will accept being contacted by selected vendors, and in response to the planner accepting contact by the selected vendors, transmit an e-mail notification to the selected vendors.

In accordance with a preferred embodiment of the invention, there is disclosed a method of determining availability for a plurality of vendors across multiple varying categories including a server having a memory configured to store data and instructions and a database stored in the memory and accessed by vendors and event planners through an internet website. comprising the steps of: inputting of a time block and date by vendor in main profile or any subsequent sub-profile indicating when a service, product, or user is not available, inputting of date by event planner indicating when an event will occur, in response to the criteria of the planner, access the database and match the planner with at least one vendor that is available on the date requested in requested category, in response to the criteria of the planner, access the database and match the planner with at least one vendor that is available on said date in all categories selected by the planner simultaneously, output to the planner a list of at least one matching vendor by date in each category selected on separate tabs, in which event planner may select named tab to view results of search for each category.

In accordance with a preferred embodiment of the invention, there is disclosed a method of matching event vendors to event planners based on overall event budget through the use of a server having a memory configured to store data and instructions and a database stored in the memory and accessed by vendors and event planners through an internet website. comprising the steps of: inputting of a minimal acceptable amount by sub-profile or by main profile if vendor charges the same rate for all applicable services, in response to the overall budget of the planner, access the database and calculate a percentage of that overall budget that an event planner would expect to pay for a specific category, output to the planner a list of at least one matching vendor in response to the overall budget of the planner, that is matched based on probably expenses associated with an event.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a block diagram of an embodiment of a system of the present invention for matching event planners with event vendors;

FIG. 2 is a flow chart of an embodiment of a method of the present invention that may be used by a bride-to-be to access the system of FIG. 1;

FIG. 3 is a flow chart of an embodiment of a method of the present invention that may be used by vendors to establish profiles in the system of FIG. 1; and

FIG. 4 illustrates a sample “dream vendor list” that may be used with the system of FIG. 1.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. A SYSTEM AND DATABASE FOR MATCHING EVENT VENDORS WITH EVENT PLANNERS IN REAL-TIME.

### BRIEF DESCRIPTION OF THE DRAWINGS

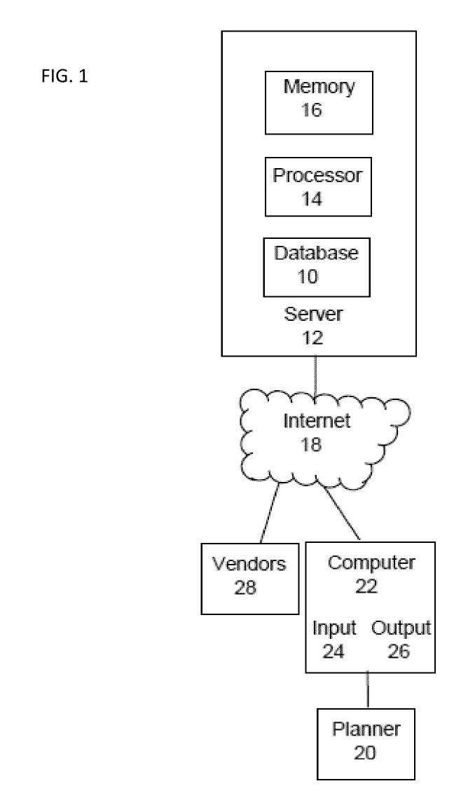

FIG. 1 is a block diagram of an embodiment of a system of the present invention for matching event planners with event vendors;

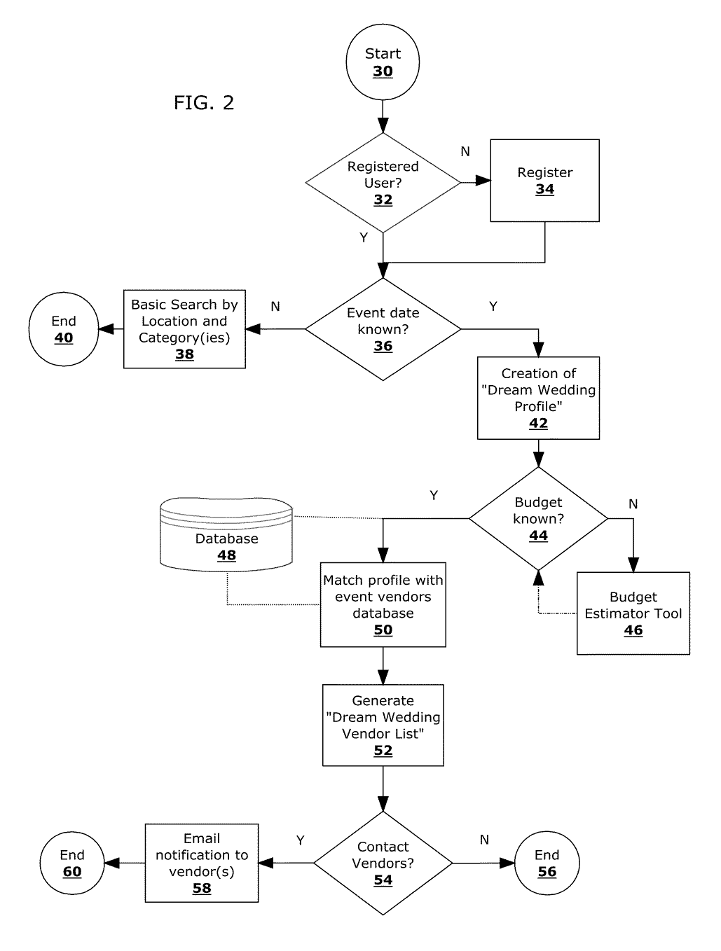

FIG. 2 is a flow chart of an embodiment of a method of the present invention that may be used by a bride-to-be to access the system of FIG. 1;

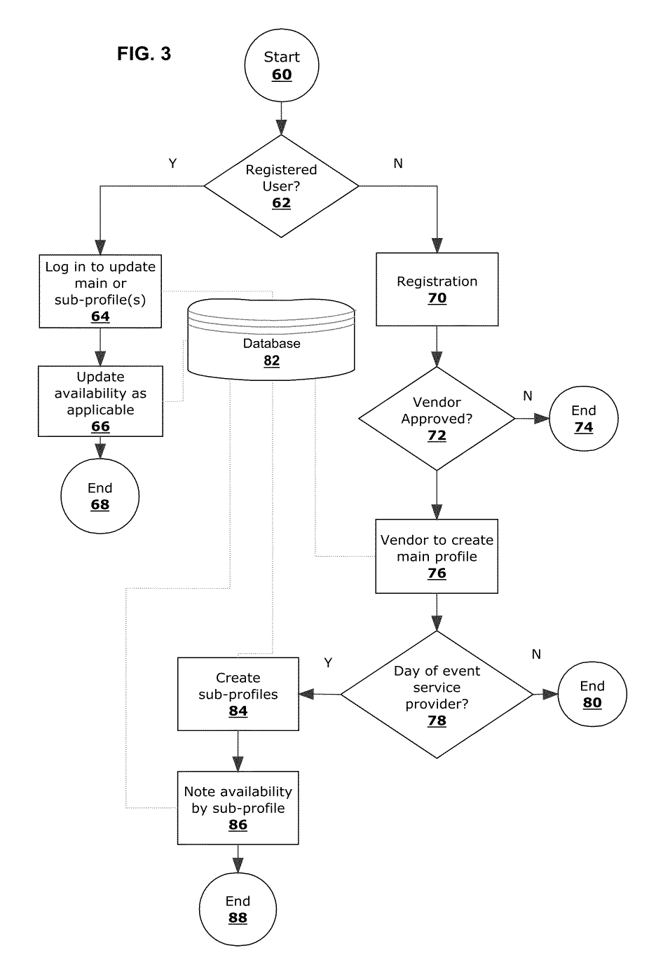

FIG. 3 is a flow chart of an embodiment of a method of the present invention that may be used by vendors to establish profiles in the system of FIG. 1; and

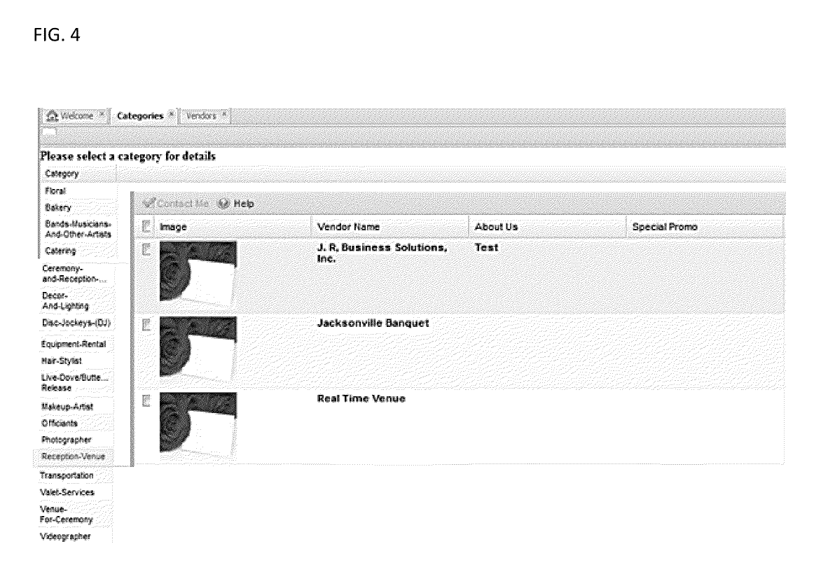

FIG. 4 illustrates a sample “dream vendor list” that may be used with the system of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a method and database for matching event vendors with event planners, such as brides-to-be.

People who are planning an event, such as a bride-to-be planning a wedding, generally hire several or many vendors, such as a flower supplier, a dress maker, a food caterer, a photographer, and a facility, to name a few. Finding out which of several vendors of each type are available on the proposed event date and at the proposed time, and which meet the planner's budget, can be time consuming and tedious and may require that the planner contact vendors individually either by phone, email, or website interface to determine suitability and availability.

In an exemplary embodiment, the system of the present invention may include a database 10 (FIG. 1) that may be stored and accessed through a server 12 or other computer. The server 12 may include a processor 14 and a memory 16 that may store the database and instructions executed by the processor 14, including instructions directed to accessing, managing, storing, outputting, and revising database entries. The server 12 may be connected to the internet 18 through which the database 10 may be accessed by an event planner 20 using a computer 22, also connected to the internet 18. Using any appropriate input 24 and output 26 devices, the planner 20 may enter information into, and receive information from, the database 10. Event vendors 28 may also access the database 10 through the internet 18.

Although the FIGs. and description refer to the present invention in the context of a bride-to-be planning for a wedding, it will be appreciated that the present invention may be used for planning any other event in which a planner and event vendors may be matched such as, for example, a banquet, a party, a conference, etc. Referring to the flowchart of FIG. 2, a bride-to-be (or other event planner) 20 may visit an internet 18 website (step 30) to register (step 34) to gain access to the full services of the database 10. Alternatively, a bride 20 who visits the internet website 18 (at step 30) and had previously registered may log in (step 32). If the event date is not known then a registered bride or other event planner 20 will be able to search for vendors by basic location and categories (step 38) and upon completion of the basic search may exit the website (step 40). Alternatively, if the event date is known, then a bride or other event planner 20 may create a “dream wedding profile” (step 42). The bride or other event planner 20 will be prompted by the system to enter a budget amount (step 44). If a budget is not determined, then the system will help the bride or other event planner 20 estimate the budget to be used (step 46). All such information created as part of the bridal profile is saved and stored in the database (step 48). The bridal form may include such criteria as the names of the bride and groom, the wedding date and location, the number of guests, the number in the bridal party, the budgeted amount for the wedding, the style and theme for the wedding, including colors, venue information, and categories of vendors to be needed both before, during and after the wedding.

Referring now to the flowchart of FIG. 3, an event vendor 28 may visit the internet website 18 (step 60) and either log in to the system as a registered user (step 62) and make changes to existing profile (step) or add/delete availability by profile or sub-profile (step). All updated information will be saved to a database 10 (step 76). Alternatively, a vendor 28 that visits the website for the first time may register to become a service provider (step 70). The vendor 28 will be reviewed to determine whether they will be approved (step 72) and if a vendor 28 is not approved then the vendor 28 may not set up a profile (step 74). If the Vendor 28 is approved after a review (step 72) then the vendor 28 may proceed to create a main profile (step 76) which will include type of business, main address, contact information, and other basic information. If the vendor 28 does not provide services on the actual day of the event, rather services related to the wedding or other event (step 78) then the Vendor will not need to provide any other information (step 80) and profile information will be saved to database 10 (step 82). If the vendor 28 provides services on the actual day of the event (step 78), has been approved (step 72) and has also created a main profile (step 76), then the vendor 28 may create sub-profiles (step 84) to include but not limited to name of sub-profile, location, capacity (if vendor), and minimally acceptable amounts. Upon creation of the sub-profiles (step 84), the vendor 28 may then update availability of each sub-profile (step 86), profile information will be saved to database 10 (step 82), and process will end for the vendor (step 88).

Referring again to FIG. 2, after the bride 20 has completed and submitted an event form (step 42), the system may access vendor profiles (step 50) and generate a “dream vendor list” (step 52) matching the bride 20 with vendors that meet the planner's criteria, which may be saved in the bride's database (step 48). The bride or event planner 20 may then select one or more vendors 15 within one or more categories that the bride or event planner 20 would like to communicate with further (step 54). A notification will be sent to the selected vendors 15 to refer the bride or event planner 20 (step 58) and the bride or event planner 20 may then exit the system (step 60). In the event a bride or event planner 20 decides not to request any further information (step 54) then no other input will be required from the bride or event planner 20 (step 56) and the bride or event planner 20 may contact vendors on their own.

It should be understood, of course, that the foregoing relates to exemplary embodiments of the invention and that modifications may be made without departing from the spirit and scope of the invention as set forth in the following claims.

What is Claimed Is:

1. A1 A System and Database for matching event vendors with event planners in real-time. comprising the steps of:
a server having a memory configured to store data and instructions ;
a database stored in the memory and accessed by vendors and event planners through an internet website and;
a processor associated with the server and configured to execute instructions to:
receive and store in the database profiles of a plurality of vendors, including a location of each vendor, one or more categories of services offered by each vendor, and charges for the services of each vendor;
receive and store in the database criteria of a planner of an event, including a date, time and place of the event, a budget for the event, a number of guests, and categories;
Method;
in response to the profile of the planner, access the database and match the planner with at least one vendor having a profile that meets at least one criteria of the planner;
output to the planner a list of the at least one matching vendor, including vendors that are available at the time of the event;
receive an input from the planner indicating one or more vendors the event planner would like to obtain more information from;
receive an input from the planner indicating whether the planner will accept being contacted by selected vendors; and
in response to the planner accepting contact by the selected vendors, transmit an e-mail notification to the selected vendors.

A2 A System and Database for matching event vendors with event planners in real-time. as claimed in claim A1 wherein said criteria of the planner is adapted to receive and store in the database multiple and varied event categories, in which all categories are independent of one another; may be further customized as the program is adapted to receive and store in the database the creation of sub-profiles within said main profile including rooms, services, or users/staff; is adapted to receive and store in the database assignment of dates not available, minimum pricing on various days, capacity (venues only) and location for each sub-profile; is adapted to receive and store in the database updates to main or sub-profile information, which will replace previously saved data; is adapted to output updated information at the onset of each search if an event planner has made changes to main or sub-profile; and is adapted to output updated information if changes are made to a vendor's main or sub-profile after the initial output is shown.

B1 A method of determining availability for a plurality of vendors across multiple varying categories including a server having a memory configured to store data and instructions and a database stored in the memory and accessed by vendors and event planners through an internet website. comprising the steps of:
inputting of a time block and date by vendor in main profile or any subsequent sub-profile indicating when a service, product, or user is not available;
inputting of date by event planner indicating when an event will occur;
in response to the criteria of the planner, access the database and match the planner with at least one vendor that is available on the date requested in requested category;
in response to the criteria of the planner, access the database and match the planner with at least one vendor that is available on said date in all categories selected by the planner simultaneously;
output to the planner a list of at least one matching vendor by date in each category selected on separate tabs, in which event planner may select named tab to view results of search for each category.

C1 A method of matching event vendors to event planners based on overall event budget through the use of a server having a memory configured to store data and instructions and a database stored in the memory and accessed by vendors and event planners through an internet website. comprising the steps of:
inputting of a minimal acceptable amount by sub-profile or by main profile if vendor charges the same rate for all applicable services;
in response to the overall budget of the planner, access the database and calculate a percentage of that overall budget that an event planner would expect to pay for a specific category;
output to the planner a list of at least one matching vendor in response to the overall budget of the planner, that is matched based on probably expenses associated with an event.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A System and Database for matching event vendors with event planners in real-time. comprising the steps of:
a server having a memory configured to store data and instructions;
a database stored in the memory and accessed by vendors and event planners through an internet website and;
a processor associated with the server and configured to execute instructions to:
receive and store in the database profiles of a plurality of vendors, including a location of each vendor, one or more categories of services offered by each vendor, and charges for the services of each vendor;
receive and store in the database criteria of a planner of an event, including a date, time and place of the event, a budget for the event, a number of guests, and categories;
Method;
in response to the profile of the planner, access the database and match the planner with at least one vendor having a profile that meets at least one criteria of the planner;
output to the planner a list of the at least one matching vendor, including vendors that are available at the time of the event;
receive an input from the planner indicating one or more vendors the event planner would like to obtain more information from;
receive an input from the planner indicating whether the planner will accept being contacted by selected vendors; and
in response to the planner accepting contact by the selected vendors, transmit an e-mail notification to the selected vendors.

2. A System and Database for matching event vendors with event planners in real-time. as claimed in claim A1 wherein said criteria of the planner is adapted to receive and store in the database multiple and varied event categories, in which all categories are independent of one another; may be further customized as the program is adapted to receive and store in the database the creation of sub-profiles within said main profile including rooms, services, or users/staff; is adapted to receive and store in the database assignment of dates not available, minimum pricing on various days, capacity (venues only) and location for each sub-profile; is adapted to receive and store in the database updates to main or sub-profile information, which will replace previously saved data; is adapted to output updated information at the onset of each search if an event planner has made changes to main or sub-profile; and is adapted to output updated information if changes are made to a vendor's main or sub-profile after the initial output is shown.

3. A method of determining availability for a plurality of vendors across multiple varying categories including a server having a memory configured to store data and instructions and a database stored in the memory and accessed by vendors and event planners through an internet website. comprising the steps of:
inputting of a time block and date by vendor in main profile or any subsequent sub-profile indicating when a service, product, or user is not available;
inputting of date by event planner indicating when an event will occur;
in response to the criteria of the planner, access the database and match the planner with at least one vendor that is available on the date requested in requested category;
in response to the criteria of the planner, access the database and match the planner with at least one vendor that is available on said date in all categories selected by the planner simultaneously;
output to the planner a list of at least one matching vendor by date in each category selected on separate tabs, in which event planner may select named tab to view results of search for each category.

4. A method of matching event vendors to event planners based on overall event budget through the use of a server having a memory configured to store data and instructions and a database stored in the memory and accessed by vendors and event planners through an internet website. comprising the steps of:
inputting of a minimal acceptable amount by sub-profile or by main profile if vendor charges the same rate for all applicable services;
in response to the overall budget of the planner, access the database and calculate a percentage of that overall budget that an event planner would expect to pay for a specific category;
output to the planner a list of at least one matching vendor in response to the overall budget of the planner, that is matched based on probably expenses associated with an event.
